(19) United States
(12) Patent Application Publication
(10) Pub. No.: US 2022/0164654 A1
(43) Pub. Date: May 26, 2022

(54) ENERGY- AND MEMORY-EFFICIENT TRAINING OF NEURAL NETWORKS

(71) Applicant: Robert Bosch GmbH, Stuttgart (DE)

(72) Inventors: Alexandru Paul Condurache, Renningen (DE); Jens Eric Markus Mehnert, Malmsheim (DE); Paul Wimmer, Filderstadt-Bonlanden (DE)

(21) Appl. No.: 17/454,213

(22) Filed: Nov. 9, 2021

(30) Foreign Application Priority Data
Nov. 26, 2020 (DE) 10 2020 214 850.3

(51) Int. Cl. G06N 3/08

(52) U.S. Cl. CPC G06N 3/08

(57) ABSTRACT

A method for training an artificial neural network (ANN) whose behavior is characterized by trainable parameters. In the method, the parameters are initialized. Training data are provided which are labeled with target outputs onto which the ANN is to map the training data in each case. The training data are supplied to the ANN and mapped onto outputs by the ANN. The matching of the outputs with the learning outputs is assessed according to a predefined cost function. Based on a predefined criterion, at least one first subset of parameters to be trained and one second subset of parameters to be retained are selected from the set of parameters. The parameters to be trained are optimized. The parameters to be retained are in each case left at their initialized values or at a value already obtained during the optimization.

### CROSS REFERENCE

The present application claims the benefit under 35 U.S.C. § 119 of German Patent Application No. DE 102020214850.3 filed on Nov. 26, 2020, which is expressly incorporated herein by reference in its entirety.

### FIELD

The present invention relates to the training of neural networks that may be used as image classifiers, for example.

### BACKGROUND INFORMATION

Artificial neural networks (ANNs) map inputs, such as images, onto outputs that are relevant for the particular application, with the aid of a processing chain which is characterized by a plurality of parameters and which may be organized in layers, for example. For example, an image classifier delivers to an input image an association with one or multiple classes of a predefined classification as output. An ANN is trained by supplying it with training data and optimizing the parameters of the processing chain in such a way that the delivered outputs have the best possible agreement with target outputs, known in advance, that belong to the particular training data.

The training is typically very CPU-intensive, and accordingly consumes considerable energy. To reduce the computational effort, it is conventional to set a portion of the parameters to zero and not train them further (referred to as “pruning”). At the same time, this suppresses the tendency toward “overfitting,” which corresponds to “memorization” of the training data instead of understanding the knowledge contained in the training data. Furthermore, German Patent Application No. DE 10 2019 205 079 A1 describes deactivating individual processing units during runtime (inference) of the ANN in order to conserve energy and reduce heat generation.

### SUMMARY

Within the scope of the present invention, a method for training an artificial neural network (ANN) is provided. The behavior of this ANN is characterized by trainable parameters. The trainable parameters may, for example, be weights via which inputs, which are supplied to neurons or other processing units of the ANN, are summed for activations of these neurons or other processing units.

In accordance with an example embodiment of the present invention, the parameters are initialized at the start of the training. Arbitrary values such as random values or pseudorandom values may be used for this purpose. It is important only that the values are different from zero, so that initially all links between neurons or other processing units are at least somehow active.

For the training, training data are provided which are labeled with target outputs onto which the ANN is to map the training data in each case. These training data are supplied to the ANN and mapped onto outputs by the ANN. The matching of the outputs with the learning outputs is assessed according to a predefined cost function (loss function).

In accordance with an example embodiment of the present invention, based on a predefined criterion, at least one first subset of parameters to be trained and one second subset of parameters to be retained are selected from the set of parameters. The parameters to be trained are optimized with the objective that the further processing of training data by the ANN prospectively results in a better assessment by the cost function. The parameters to be retained are in each case left at their initialized values or at a value already obtained during the optimization.

The selection of the parameters to be trained on the one hand and of the parameters to be retained on the other hand may be made in particular prior to starting the training, for example. However, the selection may also be made for the first time only during the training, for example, or changed as a function of the previous course of the training.

For example, if it turns out during the training that a certain parameter has hardly any effect on the assessment by the cost function, this parameter may be transferred from the set of parameters to be trained into the set of parameters to be retained. The parameter then remains at its present value and is no longer changed.

Conversely, it may turn out during the training, for example, that the training progress measured via the cost function comes to a halt because not enough parameters are trained. More parameters may then be transferred from the set of parameters to be retained into the set of parameters to be trained.

Thus, in one particularly advantageous embodiment of the present invention, in response to the training progress of the ANN, measured based on the cost function, meeting a predefined criterion, at least one parameter from the set of parameters to be retained is transferred into the set of parameters to be trained. The predefined criterion may in particular involve, for example, an absolute value and/or a change in an absolute value of the cost function remaining below a predefined threshold value during a training step and/or during a sequence of training steps.

For the retained parameters, effort is no longer required for the updating, for example for backpropagation of the value or of a gradient of the cost function for specific changes to individual parameters. In this regard, the same as with zeroing of the parameters by previous pruning, computing time and expenditure of energy are saved. However, in contrast to pruning, links between neurons or other processing units are not completely discontinued, so that less flexibility and expressiveness of the ANN is sacrificed for the reduction in computational effort.

If a decision to retain certain parameters is made only after the training has started, the ANN, at least to a certain extent, has already set the values of the parameters that have been established by the initial initialization and optionally by the previous training. In this situation, merely retaining the parameters is much less of an intervention than zeroing. Consequently, the error introduced into the output of the ANN due to retaining parameters tends to be lower than the error introduced by zeroing of parameters.

As a result, based on the requirement that only a certain portion of the parameters of a specific ANN are to be trained, with the other parameters being retained, a better training result may be achieved than with the zeroing of these other parameters within the scope of the pruning. The quality of the training result may be measured, for example, with the aid of test data that have not been used for the training, but for which, the same as for the training data, associated target outputs are known. The better the ANN maps the test data onto the target outputs, the better is the training result.

In accordance with an example embodiment of the present invention, the predefined criterion for selecting the parameters to be trained may in particular involve, for example, a relevance assessment of the parameters. Such a relevance assessment is already available if the training has not yet begun: For example, the relevance assessment of at least one parameter may involve a partial derivation of the cost function after an activation of this parameter at at least one location that is predefined by training data. For example, an evaluation may thus be made of how the assessment of the output, which the ANN delivers for certain training data, changes due to the cost function when an activation that is multiplied by the parameter in question, starting from the value 1, is changed. The training of parameters for which this change is large will presumably have a greater effect on the training result than the training of parameters for which this change is small.

The stated partial derivation of the cost function after the activation is not equivalent to the gradient of the cost function according to the parameter in question, which is computed during an optimization, using a gradient descent method.

The relevance assessment of the parameters ascertained in this way will be a function of the training data on the basis of which the ANN ascertains the outputs, with which the cost function in turn is then evaluated. If the ANN is designed as an image classifier, for example, and the relevance assessment is ascertained based on training images that show traffic signs, the ascertained relevance assessment of the parameters will then relate in particular to the relevance for the classification of traffic signs. In contrast, if the relevance assessment is ascertained based, for example, on training images from the visual quality control of products, this relevance assessment will relate in particular to the relevance for specifically this quality control. Depending on the application, completely different subsets of the total available parameters may be particularly relevant, which is somewhat analogous to the situation that in the human brain, different areas of the brain are responsible for different cognitive tasks.

A relevance assessment of parameters, however it is made available, now allows, for example, a predefined number (“Top N”) of most relevant parameters to be selected as parameters to be trained. Alternatively or also in combination therewith, parameters whose relevance assessment is better than a predefined threshold value may be selected as parameters to be trained. This is advantageous in particular not only when the relevance assessment assesses the parameters relative to one another, but also when this assessment has importance on an absolute scale.

As explained above, the distribution of the total available parameters over parameters to be trained and parameters to be retained may also be established or subsequently changed during the training. Therefore, in a further advantageous embodiment, for the relevance assessment of at least one parameter, a previous history of changes experienced by this trainable parameter during the optimization is used.

In a further advantageous embodiment of the present invention, the predefined criterion for selecting the parameters to be trained involves selecting a number of parameters, ascertained based on a predefined budget for time and/or hardware resources as parameters to be trained. This may be combined in particular with the relevance assessment, for example, in such a way that the Top N most relevant parameters, corresponding to the ascertained number, are selected as parameters to be trained. However, the parameters to be trained may also be selected based on the budget without regard to the relevance, for example as a random selection from the total available parameters.

In a further particularly advantageous embodiment of the present invention, the parameters to be retained are selected from weights via which inputs, which are supplied to neurons or other processing units of the ANN, are summed for activations of these neurons or other processing units. In contrast, bias values, which are additively offset against these activations, are selected as parameters to be trained. The number of bias values is several times smaller than the number of weights. At the same time, retaining a bias value that is applied to a weighted sum of multiple inputs of a neuron or a processing unit has a greater effect on the output of the ANN than retaining weights via which the weighted sum is formed.

Retaining parameters per se, similarly to zeroing during pruning, saves computing time and expenditure of energy for updating these parameters. At the same time, the same as for pruning, the tendency toward overfitting to the training data is reduced. As explained above, the important gain compared to pruning lies in the improved training result. This improvement is initially achieved at the cost of the various retained parameters, which are different from zero, occupying memory space.

In a further particularly advantageous embodiment of the present invention, this memory requirement is drastically reduced by initializing the parameters using values from a numerical sequence that has been generated by a deterministic algorithm, starting from a starting configuration. For compressed storage of all retained parameters, it is then necessary only to store information that characterizes the deterministic algorithm, as well as the starting configuration.

The completely trained ANN may thus be transported, for example also in a greatly compressed form, via a network. In many applications, the entity that trains the ANN is not identical to the entity that subsequently utilizes the ANN as intended. Thus, for example, a purchaser of a vehicle that travels at least partially automatedly would like to immediately use it, not train it first. In addition, most applications of ANNs on smart phones rely on the ANN already being completely trained, since neither the computing power nor the battery capacity of a smart phone is sufficient for the training. In the example of the smart phone application, the ANN must be loaded onto the smart phone, either together with the application or subsequently. In the stated greatly compressed form, this is possible in a particularly rapid manner and with little consumption of data volume.

The memory savings are greater the more parameters of the ANN that are retained during the training. For example, 99% or more of the weights of the ANN may be retained without significantly impairing the training result.

The numerical sequence on which the values for initializing the parameters are based may in particular be a pseudorandom numerical sequence, for example. The initialization then has essentially the same effect as an initialization using random values. However, although random values in particular have maximum entropy and are not compressible, an arbitrarily long sequence of pseudorandom numbers in the starting configuration of the deterministic algorithm may be compressed.

Thus, in one particularly advantageous embodiment of the present invention, a compression of the ANN is generated which includes at least
information that characterizes the architecture of the ANN;
information that characterizes the deterministic algorithm;
the starting configuration for the deterministic algorithm; and
the completely trained values of the parameters to be trained.

In one particularly advantageous embodiment of the present invention, an ANN is selected that is designed as an image classifier which maps images onto an association with one or multiple classes of a predefined classification. In particular for this application of ANN, a particularly large proportion of the parameters may be retained during the training without significantly impairing the accuracy of the classification achieved after completion of the training.

Moreover, the present invention provides a further method. Within the scope of this method, an artificial neural network (ANN) is initially trained using the method described above. The ANN is subsequently supplied with measured data that have been recorded using at least one sensor. The measured data may in particular be image data, video data, radar data, LIDAR data, or ultrasound data, for example.

The measured data are mapped onto outputs by the ANN. An activation signal is generated from the outputs thus obtained. A vehicle, an object recognition system, a system for quality control of products, and/or a system for medical imaging are/is activated via this activation signal.

In this context, as a result of the training using the above-described method of the present invention, the ANN is enabled to generate meaningful outputs from measured data more quickly, so that ultimately activation signals are generated, to which the technical system, activated in each case, appropriately responds in a situation that is detected by sensor. On the one hand, computational effort is saved, so that the training as a whole proceeds more quickly. On the other hand, the completely trained ANN may be transported more quickly from the entity that has trained it to the entity that operates the technical system to be activated, and which needs the outputs of the ANN for this purpose.

The methods described above may in particular be implemented by computer, for example, and thus embodied in software. Therefore, the present invention further relates to a computer program that includes machine-readable instructions which, when executed on one or multiple computers, prompt the computer(s) to carry out one of the described methods. In this sense, control units for vehicles and embedded systems for technical devices which are likewise capable of executing machine-readable instructions are to be regarded as computers.

Moreover, the present invention further relates to a machine-readable data medium and/or a download product that includes the computer program. A download product is a digital product that is transmittable via a data network, i.e., downloadable by a user of the data network, and that may be offered for sale in an online store, for example, for immediate download.

In addition, a computer may be equipped with the computer program, the machine-readable data medium, or the download product.

Further measures that enhance the present invention are described in greater detail below with reference to figures, together with the description of the preferred exemplary embodiments of the present invention.

### BRIEF DESCRIPTION OF THE DRAWINGS

FIG. 1 shows one exemplary embodiment of method 100 for training an ANN 1, in accordance with the present invention.

FIG. 2 shows one exemplary embodiment of method 200, in accordance with the present invention.

FIG. 3 shows the influence of retaining parameters 12b on the performance of an ANN 1 in comparison to zeroing during pruning.

### DETAILED DESCRIPTION OF EXAMPLE EMBODIMENTS

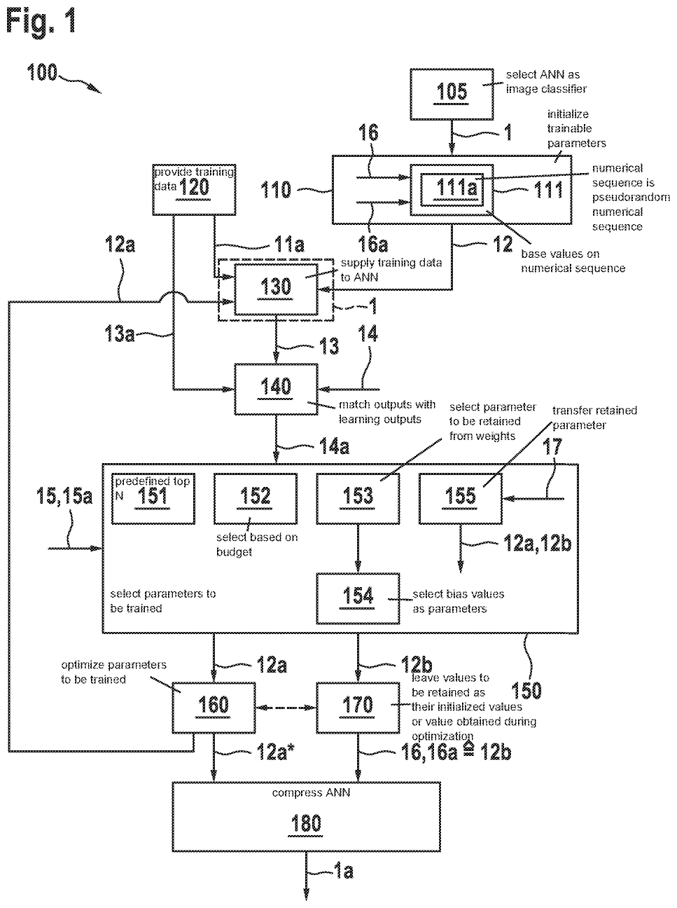

FIG. 1 is a schematic flowchart of one exemplary embodiment of method 100 for training ANN 1. An ANN 1 designed as an image classifier is optionally selected in step 105.

Trainable parameters 12 of ANN 1 are initialized in step 110. According to block 111, the values for this initialization may be based in particular, for example, on a numerical sequence that delivers a deterministic algorithm 16, proceeding from a starting configuration 16a. According to block 111a, the numerical sequence may in particular be a pseudorandom numerical sequence, for example.

Training data 11a are provided in step 120. These training data are labeled with target outputs 13a onto which ANN 1 is to map training data 11a in each case.

Training data 11a are supplied to ANN 1 in step 130 and mapped onto outputs 13 by ANN 1. The matching of these outputs 13 with learning outputs 13a is assessed in step 140 according to a predefined cost function 14.

Based on a predefined criterion 15 which in particular may also make use of assessment 14a, for example, at least one first subset of parameters 12a to be trained and one second subset of parameters 12b to be retained are selected from the set of parameters 12. Predefined criterion 15 may in particular involve, for example, a relevance assessment 15a of parameters 12.

Parameters to be trained 12a are optimized in step 160 with the objective that the further processing of training data 11a by ANN 1 prospectively results in a better assessment 14a by cost function 14. The completely trained state of parameters 12a to be trained is denoted by reference numeral 12a*.

Parameters 12b to be retained are in each case left at their initialized values or at a value already obtained during optimization 160 in step 170.

Using completely trained parameters 12a*, deterministic algorithm 16, and its starting configuration 16a, a compression 1a of ANN 1 may be formed in step 180, which is extremely compact compared to the complete set of parameters 12 that are available in principle in ANN 1. A compression by a factor in the range of 150 may be possible without a noticeable loss of performance of ANN 1.

Multiple examples of options of how parameters 12a to be trained on the one hand, and parameters 12b to be retained on the other hand, may be selected from total available parameters 12 are provided within box 150.

According to block 151, for example a predefined number Top N of most relevant parameters 12, and/or those parameters 12 whose relevance assessment 15a is better than a predefined threshold value, may be selected as parameters 12a to be trained.

According to block 152, for example a number of parameters 12, ascertained based on a predefined budget for time and/or hardware resources, may be selected as parameters 12a to be trained.

According to block 153, parameters 12b to be retained may, for example, be selected from weights via which inputs, which are supplied to neurons or other processing units of ANN 1, are summed for activations of these neurons or other processing units. In contrast, bias values, which are additively offset against these activations, may be selected according to block 154 as parameters 12a to be trained. Parameters 12a to be trained thus include all bias values, but only a small portion of the weights.

According to block 155, in response to the training progress of ANN 1, measured based on cost function 14, meeting a predefined criterion 17, at least one parameter 12 from the set of parameters 12b to be retained may be transferred into the set of parameters 12a to be trained.

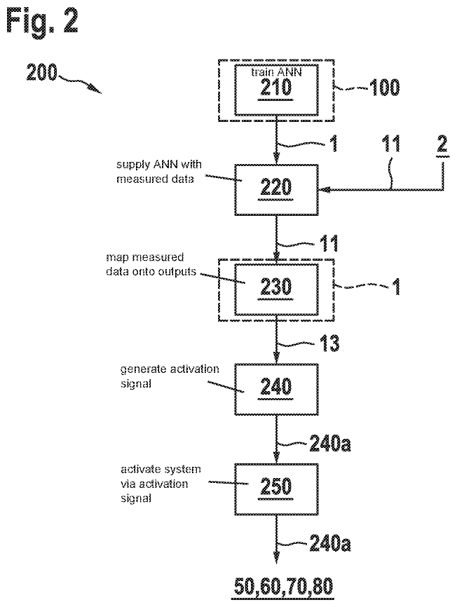

FIG. 2 is a schematic flowchart of one exemplary embodiment of method 200. An ANN 1 is trained via above-described method 100 in step 210. In step 220, this ANN 1 is supplied with measured data 11 that have been recorded using at least one sensor 2. Measured data 11 are mapped onto outputs 13 by ANN 1 in step 230. An activation signal 240a is generated from these outputs 13 in step 240. A vehicle 50, an object recognition system 60, a system 70 for quality control of products, and/or a system 80 for medical imaging are/is activated via this activation signal 240a in step 250.

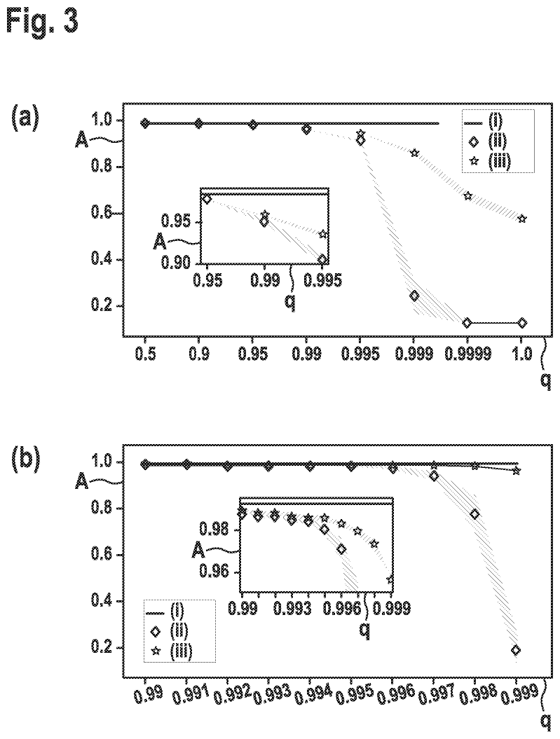

FIG. 3 shows, via two examples, how much better classification accuracy A of an ANN 1, used as an image classifier, is for a quota q of weights not to be trained, compared to parameters 12b not to be trained, when these weights 12b are not set to zero, but instead are retained in their present state. Classification accuracy A is plotted as a function of quota q in each of diagrams (a) and (b). In contrast, all bias values that are additively offset against activations in ANN 1 are further trained. Thus, parameters 12b not to be trained are selected according to block 153 in FIG. 1, and the bias values are selected as parameters 12a to be trained according to block 154 in FIG. 1. Therefore, the classification capability, even for a quota of q=1, has not yet dropped to that of the random rate.

Diagram (a) relates to an ANN 1 having the LeNet-300-100 architecture, which has been trained for the task of classifying handwritten numerals from the MNIST data set. Horizontal line (i) represents maximum classification accuracy A that is achievable when all trainable parameters 12 are actually trained. Curve (ii) shows the drop in classification accuracy A that results when particular quota q of parameters 12 is retained at its present level and is not further trained. Curve (iii) shows the drop in classification accuracy A that results when instead, particular quota q of parameters 12 is selected using the SNIP algorithm (single-shot network pruning based on connection sensitivity), and these parameters are set to zero. Curves (i) through (iii) are each indicated with confidence intervals; the variance for curve (i) disappears.

Diagram (b) relates to an ANN 1 having the LeNet-5-Caffe architecture, which likewise has been trained for the task of classifying handwritten numerals from the MNIST data set. Analogously to diagram (a), horizontal line (i) represents maximum classification accuracy A that results when all trainable parameters 12 of ANN 1 are actually trained. Curve (ii) shows the drop in classification accuracy A that results when particular quota q of parameters 12 is retained. Curve (iii) shows the drop in classification accuracy A that results when instead, particular quota q of parameters 12 is selected using the SNIP algorithm (single-shot network pruning based on connection sensitivity), and these parameters are set to zero.

In both diagrams (a) and (b), the difference in quality between retaining parameters 12 on the one hand and zeroing parameters 12 on the other hand, using an increasing quota q of parameters 12 not to be trained, becomes increasingly greater. For zeroing of parameters 12, in addition there is a critical quota q in each case for which classification accuracy A suddenly drops drastically.

What is claimed is:

1. A method for training an artificial neural network (ANN) whose behavior is characterized by a set of trainable parameters, the method comprising the following steps:
initializing the parameters;
providing training data which are labeled with target outputs onto which the ANN is to map the training data in each case;
supplying the training data to the ANN and mapping, by the ANN, the training data onto outputs;
assessing a matching of the outputs with the target outputs according to a predefined cost function;
based on a predefined criterion, selecting, from the set of parameters, at least one first subset of parameters to be trained and one second subset of parameters to be retained;
optimizing the parameters to be trained with an objective that a further processing of the training data by the ANN prospectively results in a better assessment by the cost function; and
leaving the parameters to be retained at their initialized values or at a value already obtained during the optimization.

2. The method as recited in claim 1, wherein the predefined criterion involves a relevance assessment of the parameters.

3. The method as recited in claim 2, wherein the relevance assessment of at least one of the parameters includes a partial derivation of the cost function after an activation of the at least one of the parameters at at least one location that is predefined by training data.

4. The method as recited in claim 2, wherein the predefined criterion includes selecting a predefined number of most relevant parameters, and/or parameters whose relevance assessment is better than a predefined threshold value, as the parameters to be trained.

5. The method as recited in claim 2, wherein for the relevance assessment of at least one parameter, a previous history of changes experienced by the at least one parameter during the optimization is used.

6. The method as recited in claim 1, wherein the predefined criterion involves selecting a number of parameters, ascertained based on a predefined budget for time and/or hardware resources, as the parameters to be trained.

7. The method as recited in claim 1, wherein the parameters to be retained are selected from weights via which inputs, which are supplied to neurons or other processing units of the ANN, are summed for activations of the neurons or other processing units, and bias values, which are additively offset against the activations, are selected as the parameters to be trained.

8. The method as recited in claim 1, wherein in response to a training progress of the ANN, measured based on the cost function, meeting a predefined criterion, at least one parameter from the subset of parameters to be retained is transferred into the subset of parameters to be trained.

9. The method as recited in claim 1, wherein the parameters are initialized using values from a numerical sequence that has been generated by a deterministic algorithm, proceeding from a starting configuration.

10. The method as recited in claim 9, wherein a pseudorandom numerical sequence is selected.

11. The method as recited in claim 9, wherein a compression of the ANN is generated which includes at least:
information that characterizes an architecture of the ANN;
information that characterizes the deterministic algorithm;
the starting configuration for the deterministic algorithm; and
completely trained values of the parameters to be trained.

12. The method as recited in claim 1, wherein the ANN is configured as an image classifier that maps images onto an association with one or multiple classes of a predefined classification.

13. A method, comprising the following steps:
training an artificial neural network ANN whose behavior is characterized by a set of trainable parameters, the training including:
initializing the parameters;
providing training data which are labeled with target outputs onto which the ANN is to map the training data in each case;
supplying the training data to the ANN and mapping, by the ANN, the training data onto outputs;
assessing a matching of the outputs with the target outputs according to a predefined cost function;
based on a predefined criterion, selecting, from the set of parameters, at least one first subset of parameters to be trained and one second subset of parameters to be retained;
optimizing the parameters to be trained with an objective that a further processing of the training data by the ANN prospectively results in a better assessment by the cost function; and
leaving the parameters to be retained at their initialized values or at a value already obtained during the optimization;
supplying the ANN with measured data that have been recorded via at least one sensor;
mapping, by the ANN, the measured data onto second outputs;
generating an activation signal from the second outputs; and
activation, via the activation signal, a vehicle and/or an object recognition system and/or a system for quality control of products and/or a system for medical imaging.

14. A non-transitory machine-readable data medium on which is stored a computer program for training an artificial neural network (ANN) whose behavior is characterized by a set of trainable parameters, the computer program, when executed by one or more computers, causing the one or more computers to perform the following steps:
initializing the parameters;
providing training data which are labeled with target outputs onto which the ANN is to map the training data in each case;
supplying the training data to the ANN and mapping, by the ANN, the training data onto outputs;
assessing a matching of the outputs with the target outputs according to a predefined cost function;
based on a predefined criterion, selecting, from the set of parameters, at least one first subset of parameters to be trained and one second subset of parameters to be retained;
optimizing the parameters to be trained with an objective that a further processing of the training data by the ANN prospectively results in a better assessment by the cost function; and
leaving the parameters to be retained at their initialized values or at a value already obtained during the optimization.

15. A computer configured to train an artificial neural network (ANN) whose behavior is characterized by a set of trainable parameters, the computer configured to:
initialize the parameters;
provide training data which are labeled with target outputs onto which the ANN is to map the training data in each case;
supply the training data to the ANN and map, using the ANN, the training data onto outputs;
assess a matching of the outputs with the target outputs according to a predefined cost function;
based on a predefined criterion, select, from the set of parameters, at least one first subset of parameters to be trained and one second subset of parameters to be retained;
optimize the parameters to be trained with an objective that a further processing of the training data by the ANN prospectively results in a better assessment by the cost function; and
leave the parameters to be retained at their initialized values or at a value already obtained during the optimization.
